(19) United States
(12) Patent Application Publication
(10) Pub. No.: US 2006/0099983 A1
(43) Pub. Date: May 11, 2006

(54) System and method for performing group call processing in a key telephone system

(75) Inventor: Hyun-Jung Kim, Anyang (KR)

Correspondence Address: FLESHNER & KIM, LLP, P.O. BOX 221200, CHANTILLY, VA, 20153, US

(73) Assignee: LG Electronics Inc.

(21) Appl. No.: 11/256,091

(22) Filed: Oct. 24, 2005

(30) Foreign Application Priority Data
Oct. 25, 2004 (KR) 85490/2004

(51) Int. Cl. H04Q 7/20

(52) U.S. Cl. 455/518; 455/416

(57) ABSTRACT

A system and method processes a group call of a key telephone system. When a sender requests a call, a key telephone system transmits a message including a group call mask, which indicates a recognition number of the group corresponding to the call, to every Digital Enhanced Cordless Telephone (DECT) portable device of the group using a single downlink channel. A receiving DECT portable device desired by the sender then allocates an uplink channel and transmits an LCE page response message to the key telephone system through the allocated channel. Therefore, when a key telephone system DECT fixed equipment performs a group call, the number of channels for a simultaneous call does not restrict the number of the DECT portable devices ringing.

### BACKGROUND OF THE INVENTION

1. Field of the Invention

This invention generally relates to communication systems, and more particularly to a system and method for processing a group call in a key telephone system.

2. Description of the Related Art

The amount of work performed over the phone at the workplace has increased and kept pace with the continued development of telephony networks. To meet growing demand, an electronic key telephone system utilizing micro-computer technologies was first developed to efficiently control telephony communications.

The electronic key telephone system is a simplified switching system designed to enable several users to simultaneously use the key telephone system. This is accomplished using fixed Digital Enhanced Cordless Telephone (DECT) equipment installed in the key telephone system, which connects a key telephone (e.g., a telephone device, “key phone”, having feature keys or buttons to perform multiple functions) and other ordinary telephones thereto. The electronic key telephone system includes exchange access lines (e.g., main wire lines, office lines, etc) and internal extension lines which allow users to perform voice announcements, broadcasting, incoming call rejection, remote-controlled maintenance, and the like.

FIG. 1 shows a typical configuration of a key telephone system 10. This system operates as a simplified switching system and includes DECT fixed equipment 20 mounted in one or more slots or connected thereto via a wired connection. Equipment 20 performs the function of an exchanger. Also included is a plurality of DECT portable (mobile) devices 30 that wirelessly communicate with the DECT fixed equipment for transmitting and receiving signals. The maximum number of links which the DECT fixed equipment can be simultaneously connected to is previously determined, and the total number of simultaneous calls that can be handled equals the determined maximum number of links.

The DECT fixed equipment are often provided by different manufacturers. This equipment is mounted into the slots of the key telephone system to thusly transmit and receive signals wirelessly to and from corresponding DECT portable devices 30.

The DECT portable devices occupy one radio channel in response to a call made by the key telephone system, and thereafter transmit response signals to the corresponding DECT fixed equipment.

FIG. 2 is a flowchart showing a related-art method for processing a group call for a typical key telephone system. According to this method, when a call request is generated from the sender, the key telephone system sends the call to DECT fixed equipment 20 that is part of a call group related to that call. The DECT fixed equipment respectively allocates downlink and uplink channels to each DECT portable device 30 corresponding to the call group, and thereafter transmits an LCE(Link Control Entity) page request message to each DECT portable device through an allocated downlink channel (S100).

The DECT fixed equipment is/are mounted in the slot(s) of the key telephone system or otherwise connected thereto. Among the portable devices receiving the LCE page request message, a DECT portable device which the sender ultimately wishes to communicate with transmits an LCE page response message to the key telephone system through the uplink channel allocated from the corresponding DECT fixed equipment (S102). After receiving the LCE page response message, the key telephone system only recognizes that the DECT portable device 30 is in an active state, and accordingly transmits a CC(Call Control) setup message to the DECT portable device 30 (S104). The DECT portable device having received the CC setup message then transmits a CC alerting message in response to the CC setup message to the key telephone system (S106).

After receiving the CC alerting message, the key telephone system recognizes that the DECT portable device is in a state allowing for normal processing of a call. The key telephone system then transmits a CC information (CC Info) message to the DECT portable device (S108). The CC information message includes ring data and display (LCD) control data.

Afterwards, the DECT portable device 30 starts to ring after receiving a ring control signal included in the CC Info message. The DECT portable device also displays characters or text on a display (e.g., LCD) of the DECT portable device based on an LCD control signal. At this time, if the user presses a talk button in order to place a call, a normal call connection is started, upon exchanging a CC connect message and a CC connect Ack message (S110 and S112).

The related art method has at least the following shortcomings. If the number of groups which the DECT portable device (called by the sender) belongs to exceeds the maximum number of channels through which the DECT fixed equipment can communicate, any access attempts made after the maximum number of channels is reached are ignored. Thus, there are limits in providing desired services. That is, for DECT fixed equipment which only provides a maximum of two traffic channels, any access attempt for a third channel is ignored.

Thus, in the related-art, DECT fixed equipment 20 and DECT portable device 30 are connected to each other in a 1:1 manner, which substantially restricts the number of the portable devices which can receive a call when a group call is performed.

### SUMMARY OF THE INVENTION

An object of the invention is to solve at least the above problems and/or disadvantages and to provide at least the advantages described hereinafter

Another object of the present invention is to provide a system and method for processing a group call in a key telephone system, in which the group call may be performed for DECT portable devices of the key telephone system and accordingly the number of channels capable of communicating simultaneously is not restricted.

These and other objects and advantages of the present invention are achieved by providing a system and method for processing a group call of a key telephone system comprising: receiving a call from a sender; transmitting messages to receiving devices of a group corresponding to the call; and starting a call connection between the sender and a receiver after a receiving device selected by the sender among the receiving devices of the group transmits a response message. Preferably, the key telephone system transmits messages to the receiving devices using one downlink channel. Also, the receiving devices preferably store recognition numbers of corresponding groups.

### BRIEF DESCRIPTION OF THE DRAWINGS

FIG. 1 shows a related-art key telephone system.

FIG. 2 is a flowchart showing steps included in a related-art method for processing a group call of a typical key telephone system.

FIG. 3 shows one example of an LCE page request short format message according to the present invention.

FIG. 4 shows one possible ring pattern allocation value of the LCE page request short format message that may be used in accordance with the present invention.

FIG. 5 shows an example of bits of the LCE page request short format message.

FIG. 6 shows an address section of a CLMS fixed message according to one embodiment of the present invention.

FIG. 7 shows a data session of the CLMS fixed message according to one embodiment of the present invention.

FIG. 8 is a flowchart showing steps included in a method for processing a group call of a key telephone system according to an embodiment of the present invention.

### DETAILED DESCRIPTION OF THE INVENTION

The present invention, in at least one embodiment, relates to calling a plurality of mobile devices (e.g., DECT mobile devices, mobile equipment, etc) within a group using a single group call, instead of placing an individual call to every mobile device. This may be achieved, in one way, by employing a group call mask in an LCE page request message for transmission.

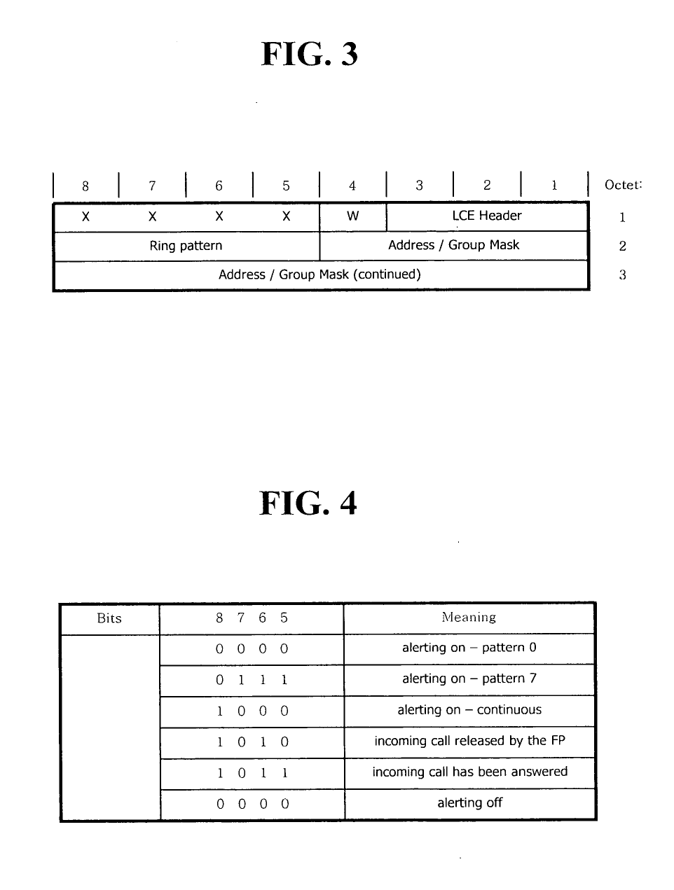

FIG. 3 shows an example of an LCE page request short format message that may be used in accordance with one embodiment of the present invention. This exemplary LCE page request short format message includes three octets. For example, the 1^{st} to 3^{rd} bits of a first octet form an LCE header, the 4^{th} bit is set as ‘W’, and the 5^{th} to 8^{th} bits are set as ‘X’. The 1^{st} to 4^{th} bits of the second octet and the 1^{st} to 8^{th} bits of the third octet are set as an ‘address/group mask’ for indicating group information of the DECT mobile devices.

FIG. 4 shows examples of ring pattern allocation values of the LCE page request short format message of FIG. 3, according to one embodiment of the present invention. As shown, if the values of the 5^{th} to 8^{th} bits of the first octet are ‘0000’, this indicates an alerting on—pattern 0. If the values of a ring pattern are ‘0111’, this indicates an alerting on—pattern 7. If the values of the ring pattern are ‘1000’, this indicates an alerting on—continuous. In addition, if the values of the ring pattern are ‘1010’, this indicates an incoming call released by the Frame Protocol (FP). If the values of the ring pattern are ‘1011’, this indicates that the incoming call has been answered. If the values of the ring pattern are ‘1111’, an alerting off is indicated. Here it is understood that various other bit combinations may be used to denote the alert status relating to incoming calls.

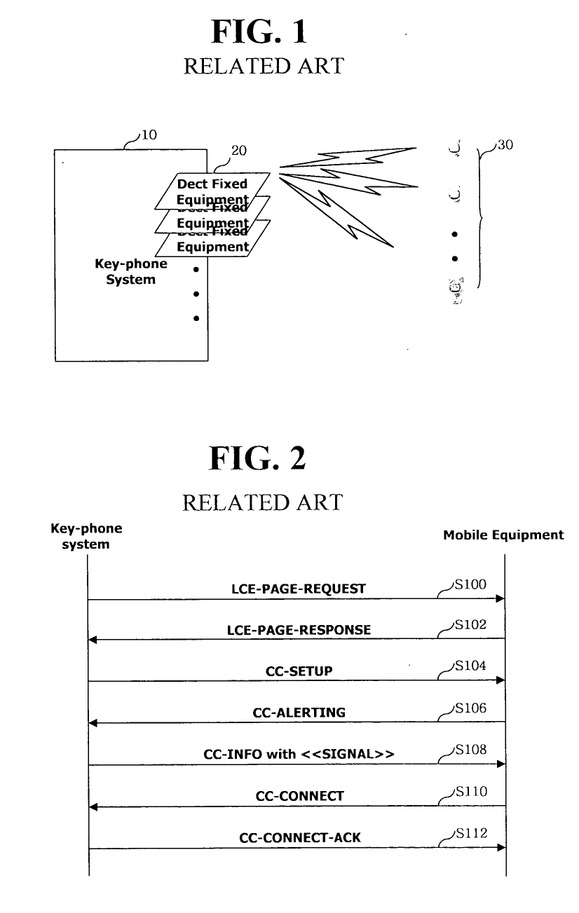

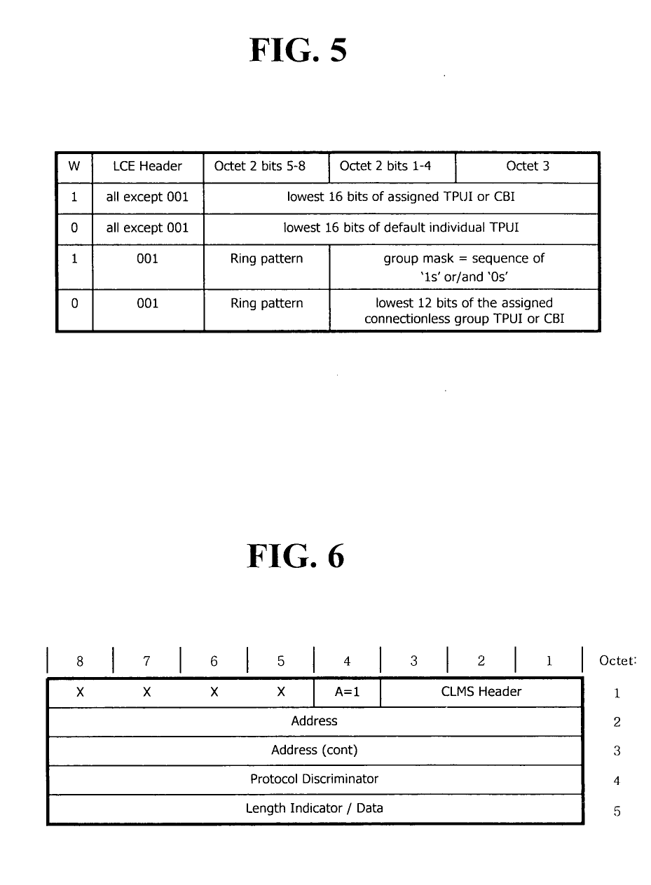

FIG. 5 shows examples of bits of the LCE page request short format message shown in FIG. 3. As shown, if ‘W(Word)’ is set to ‘1’, the LCE header may be set to ‘011’. And, if arbitrary values among values from ‘0‘to ’8’ are set to create the ring pattern value to thusly use a total of 12 bits, it is possible to perform a call simultaneously to one or more groups (i.e., a maximum of 12 groups) using a single signal transmission. Thus, for calling DECT portable devices belonging to one or more groups, the DECT fixed equipment 20 periodically transmits a ConnectionLess Message Service (CLMS) fixed message to the DECT portable (mobile) devices 30, referencing, for example, the illustrative system shown in FIG. 1. Each DECT portable device may then modify and store (remember) the group to which it currently belongs based on the received CLMS fixed message.

FIG. 6 shows an example of an address section of a CLMS fixed message according to the present invention. As illustrated, the address section includes a CLMS header, an address, a protocol discriminator, and a length indicator/data. The Address field shall only be derived from a connectionless TPUI(Temporary Potable User Identifier), and The Address(cont) field has the lowest 16 bits connectionless TPUI. So, The CLMS service requires the use of assigned TPUIs.

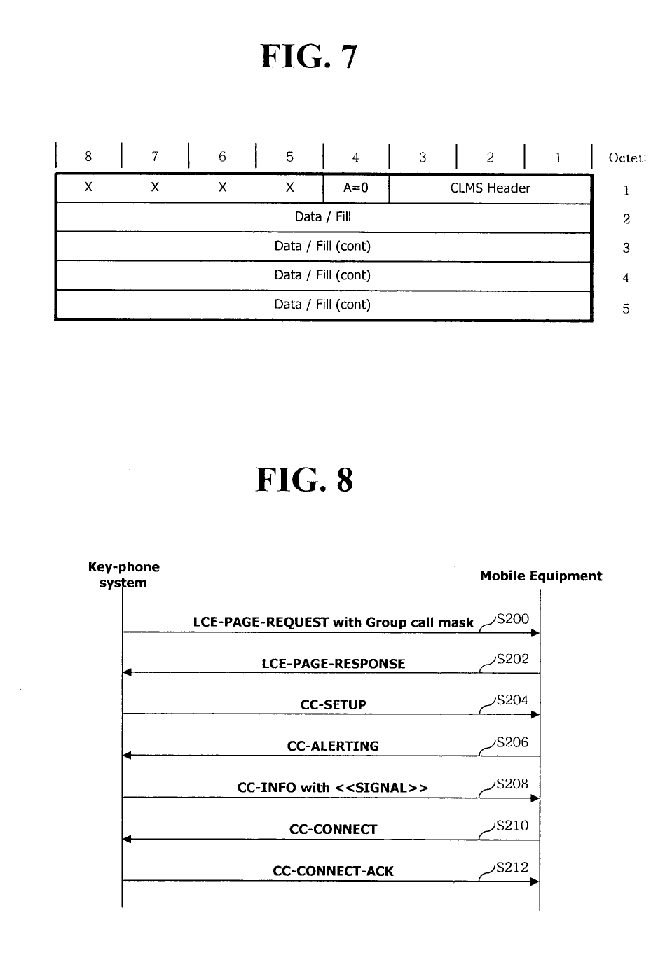

FIG. 7 shows an example of a data section of a CLMS fixed message according to the present invention. As illustrated, because a data field of the data section allows implementation of an independent protocol according to DECT manufacturers, the group information of the DECT portable device 30 can be stored in this data field, and then the CLMS fixed message may be transmitted to the DECT portable device. As a result, the DECT portable devices 30 can recognize the corresponding group information by means of the CLMS fixed message.

FIG. 8 is a flowchart showing steps included in a method for processing a group call of a key telephone system according to one embodiment of the present invention. These steps may be explained with reference to the illustrative system shown in FIG. 1, but it is noted that the method of the present invention may be performed using other systems.

When a call request is received from the sender, the key telephone system 10 transmits an LCE page request short format message (having a group call mask, which indicates a recognition number of a group corresponding to the call) to a plurality and preferably all DECT portable devices of the group, using a single downlink channel (S200).

Among the DECT portable devices which received the LCE page request short format message, a DECT portable device belonging to a reception group desired by the sender displays a message (e.g., ‘Ringing’) on its display (e.g., an LCD), and starts to ring or provide some other type notification to the user. A user recognizes the ring and presses a talk button, or some other means of activation, to allocate an uplink channel and to transmit an LCE page response message to the key telephone system 10 through the allocated channel (S202). After receiving the LCE page response message, the key telephone system 10 recognizes that the DECT fixed equipment 20 is in an active state and that the user has responded. The system then transmits a CC setup message to the DECT portable device 30 (S204). After receiving the CC setup message, the DECT portable device 30 displays Caller ID (CID) information on its display (LCD) if CID information exists, and transmits a CC alerting message in response to the CC setup message to the key telephone system 10 (S206).

After receiving the CC alerting message, the key telephone system recognizes that the DECT portable device is in a state of having normally received the call, and then transmits a CC information (CC Info) message including LCD control data to the DECT portable device 30 (S208). Thereafter, the DECT portable device 30 displays characters (or text, graphics, etc) on its display screen, such as an LCD, on the basis of the LCD control signal included in the CC Info message. Accordingly, the user can start to perform a normal call by exchanging a CC connect message and a CC connect Ack message (S210 and S212).

In the method for processing a wireless telephone group call of the key telephone system according to one or more of the foregoing embodiments of the present invention, one advantage that can be achieved is that the number of DECT portable devices 30 that ring at the time of performing a group call with the DECT fixed equipment of the key telephone system is not restricted to the number of simultaneous traffic channels being used.

The present invention may be embodied in several forms without departing from the spirit or essential characteristics thereof. It should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method for processing a group call of a key telephone system, comprising:
receiving a call from a sender;
transmitting a first message to a plurality of receiving devices in a group corresponding to the call; and
starting a call connection between the sender and a receiver after a receiving device selected by the sender among the receiving devices of the group transmits a second message.

2. The method of claim 1, wherein transmitting the first message is performed after a channel is allocated for message transmission.

3. The method of claim 1, wherein the receiving devices are Digital Enhanced Cordless Telephone (DECT) portable devices.

4. The method of claim 1, wherein the first message informs the plurality of receiving devices of a group call request.

5. The method of claim 4, wherein the first message includes an LCE page request short format message.

6. The method of claim 1, wherein the first message includes a recognition number of the group.

7. The method of claim 6, wherein the recognition number is a group mask.

8. The method of claim 6, wherein the call can be performed using a recognition number for a maximum number of groups based on a number of bits allocated to the group mask in the first message.

9. The method of claim 1, wherein the selected receiving device allocates an uplink channel and thereafter transmits the second message as a response message.

10. A method for processing a group call of a key telephone system, comprising:
receiving a call from a sender;
transmitting a message indicative of a group call request to a plurality of receiving devices in a group corresponding to the call;
allocating an uplink channel from a selected one of the receiving devices; and
transmitting a response message through the allocated channel and thereafter starting a call connection between the sender and a selected one of the receiving devices.

11. The method of claim 10, wherein the receiving devices are Digital Enhanced Cordless Telephone (DECT) portable devices.

12. The method of claim 10, wherein the message includes an LCE page request short format message.

13. The method of claim 10, wherein the message includes a recognition number of the group.

14. The method of claim 13, wherein the recognition number is a group mask.

15. The method of claim 13, wherein a call can be performed using a recognition number for a maximum number of groups based on a number of bits allocated to the group mask in the first message.

16. The method of claim 10, wherein the selected receiving device allocates the uplink channel and then transmits the response message.

17. A method of forming a page request short format message, comprising:
inserting LCE header information in a first field; and
inserting a group mask into at least a second field,
wherein the group call mask includes information identifying a plurality of digital enhanced cordless telephone mobile devices in a group.

18. The method of claim 17, wherein the group call mask allows the mobile devices in the group to ring irrespective of simultaneous traffic channels being used by DECT filed equipment.

19. The method of claim 17, wherein at least a portion of the group mask information is combined with address information of said message in a same field.

20. The method of claim 17, further comprising:
inserting ring pattern information is a third field.

21. The method of claim 17, further comprising:
sending said message from a key telephone system to the mobile devices in the group over a single channel.
